(19) United States
(12) Patent Application Publication
(10) Pub. No.: US 2022/0109731 A1
(43) Pub. Date: Apr. 7, 2022

(54) SYSTEMS AND METHODS FOR REAL-TIME TRACKING OF CLIENT DATA ACCESS

(71) Applicant: PureInfluencer LLC, Arroyo Grande, CA (US)

(72) Inventors: Ronald G. Morrison, Arroyo Grande, CA (US); Ryan Richard Jenkins, Manassas, VA (US); Jordan Kalani Morrison, Arroyo Grande, CA (US); Nikolay Dimitrov Kondikov, Sofia (BG); Alexander Stefanov Yosifov, Varna (BG); Teodor Savkov Danailov, Varna (BG); Slavcho Vladkov Vatahov, Sofia (BG)

(73) Assignee: PureInfluencer LLC, Arroyo Grande, CA (US)

(21) Appl. No.: 17/197,863

(22) Filed: Mar. 10, 2021

Related U.S. Application Data
(60) Provisional application No. 63/087,752, filed on Oct. 5, 2020.

(51) Int. Cl. H04L 29/08; H04L 29/06

(52) U.S. Cl. CPC H04L 67/142; H04L 67/42; H04L 69/28; H04L 67/141; H04L 67/146

(57) ABSTRACT

In some aspects, the disclosure is directed to methods and systems for real-time tracking or monitoring of client device access during sessions as well as across or between sessions, and aggregation of monitoring data. Monitored data may be used to generate predictive scores for identification of anomalous or non-anomalous behavior, or predict success or failure of an access session or access to a given content item or page. By utilizing real-time monitoring and analysis, administrators may take proactive or mitigation actions dynamically, without waiting for requests from users of client devices and without the delay of offline analysis of logs.

### RELATED APPLICATIONS

This application claims the benefit of and priority to U.S. Provisional Patent Application No. 63/087,752, entitled “Systems and Methods for Real-Time Tracking of Client Data Access,” filed Oct. 5, 2020, the entirety of which is incorporated by reference herein.

### FIELD OF THE DISCLOSURE

This disclosure generally relates to systems and methods for network communications. In particular, this disclosure relates to systems and methods for real-time tracking of client data access to content, such as web pages.

### BACKGROUND OF THE DISCLOSURE

Tracking of visitors to websites is typically performed via aggregation and analysis of tracking or browsing logs offline, in non-real-time, with such aggregation and analysis performed periodically (e.g. daily, weekly, monthly, etc.). While such analytics may provide generalized insight into website and data usage, they do not provide immediately actionable insight due to their non-real-time nature. In particular, in systems that do not track website usage by individual clients in real-time, administrators or system users are not able to take proactive responses to clients' communications issues or behaviors in real-time.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is an illustration of an example of pathing tracking of client data access across a website, according to some implementations;

FIG. 1B is a conceptual information model of tracked device characteristics across sessions accessing a website, according to some implementations;

FIG. 1C is an illustration of an example display of real-time access analysis for multiple client devices, according to some implementations;

FIG. 1D is an illustration of icons of the display of FIG. 1C, according to some implementations;

FIG. 2A is a block diagram of a system for real-time tracking of client data access, according to some implementations;

FIG. 2B is a flow chart of a method for real-time tracking of client data access, according to some implementations;

FIGS. 3A-3F are screenshots of user interfaces of a system for real-time tracking of client data access, according to some implementations; and

FIGS. 4A and 4B are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for real-time tracking of client data access; and
Section B describes a computing environment which may be useful for practicing embodiments described herein.

### A. Systems and Methods for Real-Time Tracking of Client Data Access

Tracking of visitors to websites is typically performed via aggregation and analysis of traffic or browsing logs offline, in non-real-time, with such aggregation and analysis performed periodically (e.g. daily, weekly, monthly, etc.). For example, in some implementations, tracking agents or plug-ins on client devices may record browsing or behavior logs and periodically provide the logs to an analyzer server for aggregation and analysis. As a result, the analysis may be significantly delayed, and only reactive actions may be taken. In other implementations, intrusive messages or pop-ups may be provided to each user to execute tracking scripts or provide additional content. In some implementations, such content may be targeted based on tracking cookies or other identifiers (e.g. based on referrer tags or a page or domain that was visited by a client device prior to the current page), but may not be selected responsive to specifics of the client device's communication session with the web server, such as pages visited, duration spent, etc. In instances where behavior or communications are anomalous and mitigation actions could be taken, if there had been real-time tracking, the absence of such tracking may result in delayed or improper responses. In particular, in systems that do not track website usage or visits by individual clients in real-time, administrators or system users are not able to take proactive responses to clients' communications issues or behaviors in real-time.

Instead, the systems and methods discussed herein provide for real-time tracking and analysis of a client device's access to data or content, such as pages of a website, web applications, online databases, or other such content. The device's access may be monitored and classified according to a machine learning-based system (e.g. a k-Nearest Neighbor classifier, Bayes classifier, neural network, etc.) and the communication session and/or device may be classified. Proper classification may allow for preventative actions, mitigation actions, or other proactive actions to be selected or performed dynamically in real-time, without the delays or limited knowledge present in other systems.

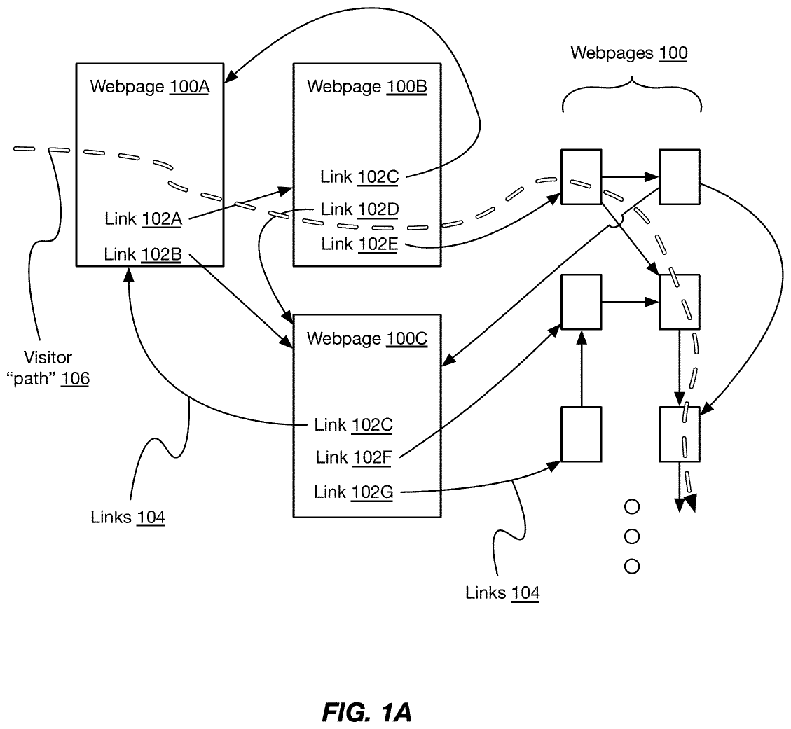

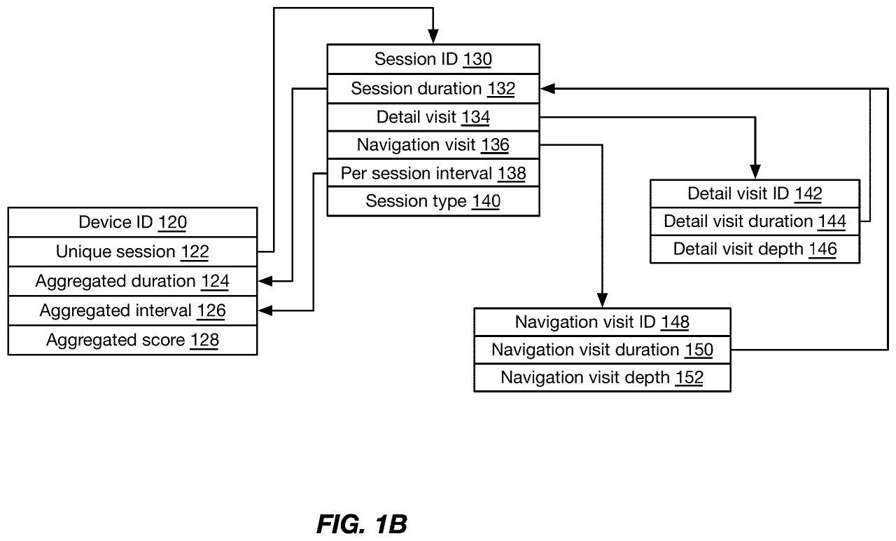

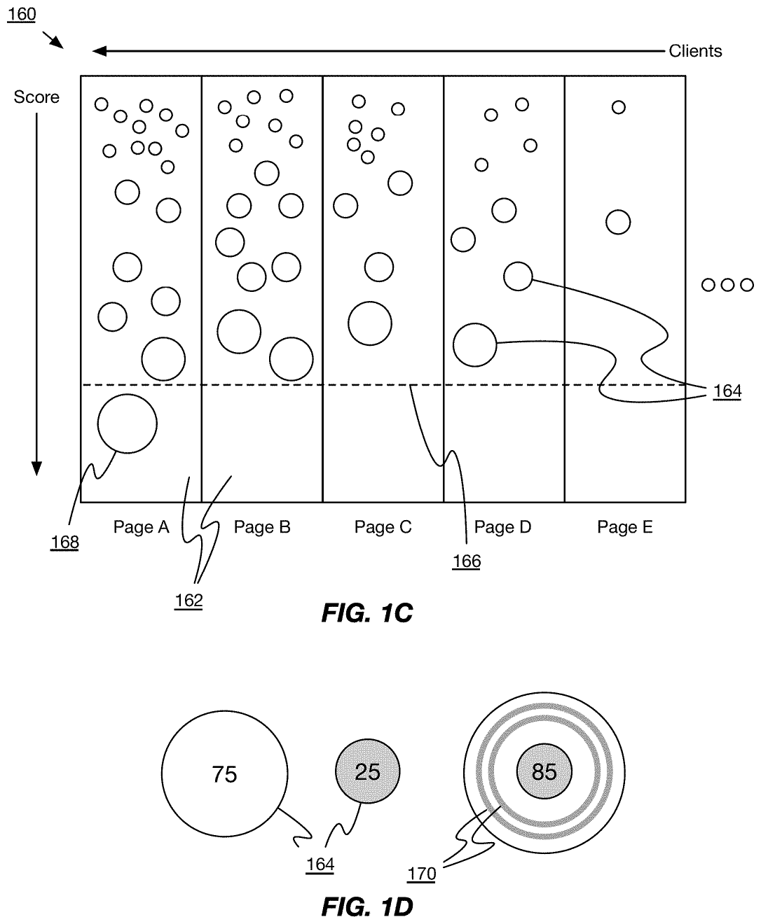

As discussed above, in many implementations, client devices may access multiple pages across a website during a session. FIG. 1A is an illustration of an example of pathing tracking of client data access, according to some implementations. As shown, a website may comprise a plurality of webpages 100 (e.g. webpages 100A, 100B, 100C, etc.). Each webpage may comprise one or more links 102A-102G, which may direct client devices to other webpages 100 (shown with solid arrows) or external webpages (e.g. at different domains), or perform other functions (e.g. loading scripts, downloading files, accessing web applications, etc.). A client device accessing the website may access one or more webpages 100 in sequence, following various links 102, and spending varying amounts of time on each page. An example of such a sequence is shown in dashed line (e.g. visitor path 106).

As discussed above, the systems and methods discussed herein provide for real-time monitoring and tracking of access of client devices, including sequences of access. Data about each client device and access to web pages or other content may be recorded and a state maintained for each device. FIG. 1B is a conceptual information model of tracked device characteristics across sessions accessing a website, according to some implementations. Each device may be associated with an identifier 120, which may comprise a globally unique identifier (GUID) or similar identifier. The identifier 120 may be generated randomly or may be generated as a function of one or more items of information about the device (e.g. concatenating or otherwise combining one or more values such as a MAC address, device type, account name, IP address, etc.). Each identifier may be associated with one or more sessions 122, which may comprise unique instances of access to the tracked webpages (e.g. within a domain or across domains). In some implementations, sessions may be based on time (e.g. all access to content or pages by a device within a predetermined period such as an hour, day, week, etc. may be associated with a single session), while in other implementations, sessions may be based on instances of unique access to an initial webpage (e.g. an index page or starting page of a website, sometimes referred to as a landing page), with links followed from that page associated with the same session, and a new session recorded if the device re-accesses the initial page.

Each session may be associated with a unique ID 130, which may be generated incrementally or randomly in various implementations. Session durations 132 (e.g. the amount of time a device accessed a page or content) may be tracked in various implementations. For example, in some implementations, a timer script may be embedded on each page and executed by a client device's web browser to count the time (e.g. in seconds) that the client is accessing the page or content, with the total transmitted to the tracking server periodically or on exit from the page. In other implementations, a script on each page may periodically request an update from the server, and the server may record subsequent requests associated with the same page as indicating a continuous time of access (e.g. a first access at 00:00, an update at 00:05, and a second update at 00:10 with no further updates may be recorded as a duration of 00:10). In still other implementations, access to content or a page may comprise a continuous flow of data, such as via a web application, and a total duration of the flow may be tracked and recorded. In many implementations, multiple session durations 132 may be aggregated and stored as an aggregated duration 124 for the device identifier 120.

Each session identifier 130 may also be associated with a set of pages or content accessed by the device during the session. Such pages or content may, in some implementations, be divided into categories, such as a detail page 134 or a navigation page 136. Navigation pages 136 may comprise pages with search interfaces or results, menus, or other navigation interfaces, and may be tracked separately from detail pages 134, which may comprise pages with other content (e.g. substantive content, web applications, etc., other than navigation pages). In some implementations, navigation pages and detail pages may be tracked separately due to the distinct behaviors of devices accessing such pages: navigation pages are typically precursors to access to detail pages, while detail pages may be content that is finally accessed by a client device before terminating a session or may be accessed prior to other detail pages or navigation pages. As such, the duration of access and subsequent chain of access may be drastically different between detail pages and navigation pages, and accordingly, it may be helpful to identify anomalous or important device access behavior from statistics separately aggregated for these categories. In other implementations, additional categories may be utilized (e.g. login pages, content generation pages such as email or form interfaces, web applications, content consumption pages such as pages with embedded media players, etc.).

Each detail page may be associated with an identifier 142, such that visits to each page may be tracked per session as discussed above. In some implementations, multiple visits to a page may be counted and stored in association with identifier 142 for tracking behavior and/or anomalies during session access. A duration of access to each detail page 144 may also be recorded, for example using the methods discussed above for tracking of session durations. Additionally, in some implementations, a scroll depth 146 of access to the detail page may be recorded (e.g. 25% of the page, 50% of the page, 100% of the page, etc.). Similarly, in some implementations, each navigation page may be associated with an identifier 148, an access duration 150 of the navigation page tracked, and a scroll depth 152 of access to the navigation page recorded.

As discussed above, a client device may access web pages during different access sessions, such as one day to the next. In some implementations, intervals between access sessions may be recorded and associated with each session as a per session interval 138. These intervals may also be aggregated into a total aggregated interval (e.g. total time between access visits for the last n days). In some implementations, more or less frequent sessions than average may indicate an anomaly.

Each client device may be associated with an aggregated score 128. Aggregated score 128 may comprise a dynamically adjusted score representing a total value for interactions with the website by each client device. The score may comprise a function of the number of sessions, aggregated session duration 124, aggregated session interval 126, per session durations, detail and/or navigation page views, durations, or scroll depths, or any other such values. For example, in one implementation, the aggregated score may comprise a sum of C₁[number of sessions]+C₂[aggregated session duration in seconds]+C₃[per session interval in seconds]+C₄[number of detail pages accessed]+C₆[duration of detail page accesses]+C₇[detail page scroll depth]+C₈[number of navigation pages accessed]+C₉[duration of navigation page accesses]+C₁₀[navigation page scroll depth]−C₁₀[aggregated session interval in seconds], with C₁ through C₁₀ being scoring coefficients. The score may be compared to a threshold at any time (e.g. between sessions or during a session) to detect whether a session or access by a device is anomalous, such that proactive or mitigation actions may be taken (e.g. limiting access by the device, increasing access controls for the device, transmitting a prompt or other content to the device such as a help file or other data, initiating a live chat session with the device and an administrator, etc.

In some implementations, coefficients C₁ through Cm may be adjusted by an administrator, while in other implementations, the coefficients may be dynamically set by a machine learning algorithm. For example, in some implementations, each of the sub-score values (e.g. durations, depth, accesses, etc.) may be provided as inputs to a neural network, with coefficients provided by hidden layer functions, and an output indicating a score or classification (e.g. a value of 1-10, a classification of “normal” or “anomalous”, etc.). In some implementations, the neural network may be trained in a supervised learning process on data from previously recorded sessions that is manually classified by an administrator; or may be trained on an unsupervised learning process to detect anomalous behavior that is different from the majority of accesses. In some implementations, access during a session to a specific page may be used as a classification for the neural network in a supervised learning process (e.g. with a predictive score for whether the page will be accessed or not being the output of the neural network). Such specific page may comprise a help page, error page, access request page, authorization page, checkout page, or any other type and form of page that may indicate success or failure of an access session for the website. By using such a classification, new sessions may be dynamically tracked and the classifier may predict whether the session will be successful or unsuccessful in advance, such that mitigation or proactive actions may be taken.

In some implementations, a display of the results of the real-time analysis may be provided to an administrator for review and for taking proactive or mitigation actions. FIG. 1C is an illustration of an example of one such display of real-time access analysis for multiple client devices, according to some implementations. A traffic lane display 160 may comprise a plurality of lanes 162, each lane corresponding to a page of a plurality of webpages or other such content (e.g. web applications, media, etc.). Bubbles or icons 164 may be displayed within each lane to indicate a client currently accessing the corresponding page or content. As shown, in some implementations, the lanes may be dynamically sorted in order of number of client devices accessing each page (e.g. from most to least). Similarly, bubbles or icons 164 may be displayed in larger sizes as their corresponding scores increase and/or, in some implementations, may be displayed lower (or higher) in the lane 162 as shown. In some implementations, a score threshold 166 may be displayed, such that the administrator viewing the display may immediately identify an icon 168 corresponding to a client device that is displaying anomalous behavior.

Although shown as empty circles for clarity, in some implementations, additional detail may be displayed on each icon 164. For example, FIG. 1D is an illustration of example icons of the display of FIG. 1C, according to some implementations. As shown, in some implementations, icons 164 may be displayed in larger sizes corresponding to a score associated with the client device, which may be displayed within the icon in some implementations.

In some implementations, initial access to a session or a domain from which the client device was referred may be recorded and may be utilized to classify client devices or sessions. Such initial access or referral types may include a referral from a search provider (e.g. arriving at a webpage from a link provided in search results), a referral from a social networking site (e.g. via a link from a social network or social media site), or a client that accessed the session directly (e.g. arriving at a webpage with no referrer link). In some implementations, these or other access referrer types may be displayed as part of the icon 164, e.g. as a color or shading. For example, a direct access to a session may be a white bubble or icon as shown at left, while a referred access from a search provider may be a shaded bubble as shown in middle. In some implementations, multiple shadings may be shown for multiple accessed across a plurality of sessions for a client device. For example, as shown at right, an initial visit (smallest circle) may be shaded to show a referral, while a second or third visit may be unshaded (white area around the smallest circle) to show a direct access, a fourth visit may be shaded (first band 170 around the white circle) to show a referral, a fifth visit may be unshaded (white portion between bands 170) to show a direct access, a sixth visit may be shaded (second band 170 around the white circle) to show a referral, with a white band around that to show subsequent direct accesses. Various combinations of shadings may be utilized to display types for a plurality of subsequent accesses.

In some implementations, selecting an icon within the display 160 of FIG. 1C may result in display of additional information about the client, such as a current score; a current session duration; a total number of visits by the client; dates, times, and durations for other visits; and/or a journey listing of all previous pages visited with corresponding dates and, in some implementations, what the score associated with the client device was during those visits. In some implementations, the administrator may be able to select to apply a proactive or mitigation action to a client device via the interface (e.g. clicking on the icon corresponding to the client device and selecting from one or more actions to apply, including blocking access, elevating or reducing privileges, initiating a chat session, sending a link to additional content to client device (e.g. for display in a browser pop-up or notification), providing additional content directly to the client device (e.g. for display in a browser pop-up or notification), or other such actions).

In some implementations, the administrator may be able to filter the view of display 160 or select different views, such as viewing all live accesses (e.g. currently connected client devices), viewing accesses at a specified date or time or range of dates or times, viewing only accesses by devices that were referred from another domain or search provider, viewing only accesses by devices that accessed pages directly (e.g. without a referrer tag), viewing a subregion or range of scores, or otherwise filtering to display a subset of icons 164.

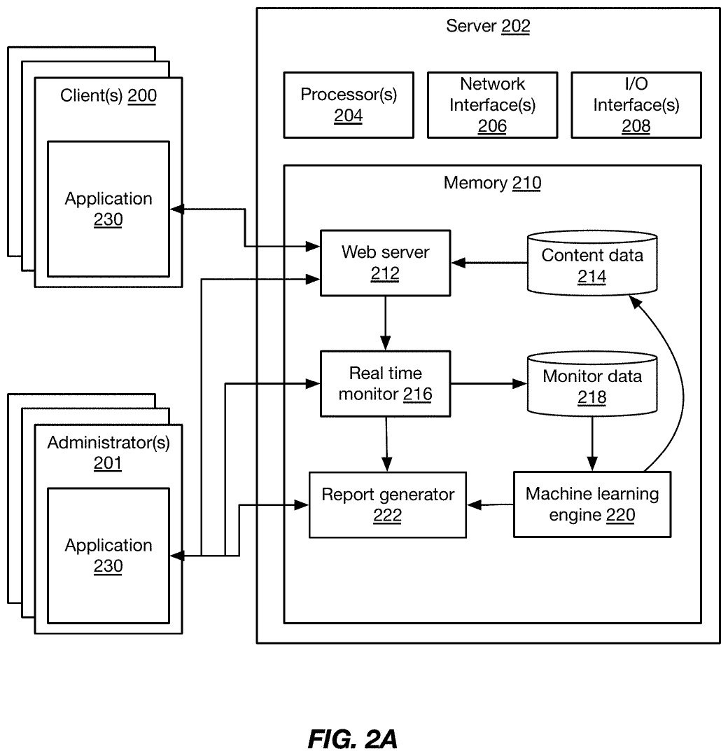

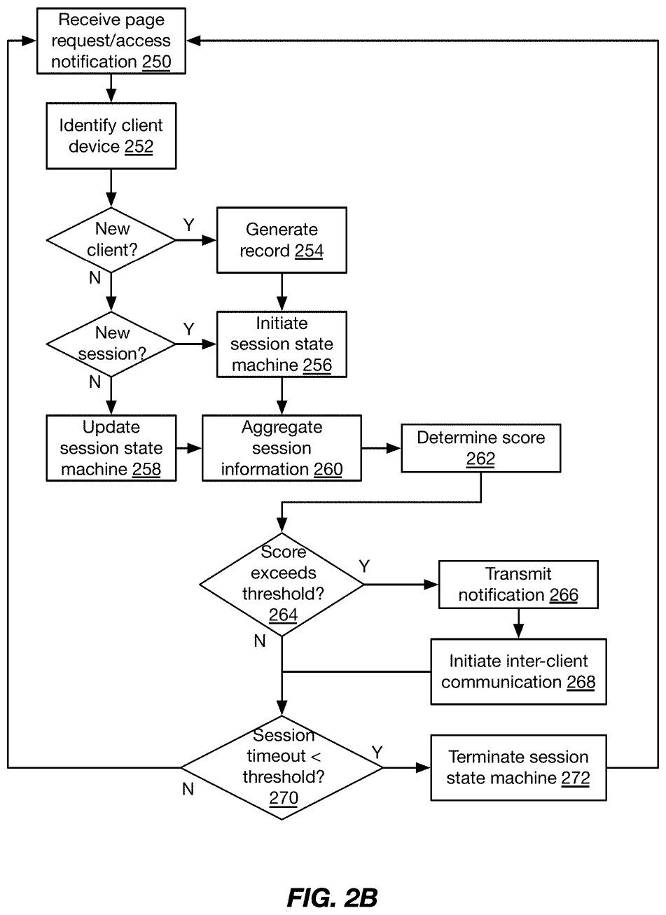

FIG. 2A is a block diagram of a system for real-time tracking of client data access, according to some implementations. As shown, a plurality of client devices 200 and/or administrator devices 201 may communicate with one or more servers 202. Client devices 200 and/or administrator devices 201 may comprise laptop computers, desktop computers, smartphones, tablet computers, wearable computers, embedded computers, or any other type and form of computing device. Similarly, servers 202 may comprise desktop computers, workstations, server computers, rackmount computers, appliances, clusters of computing devices, virtual computing devices executed by one or more physical computing devices and deployed as a cloud, or any other type and form of computing device or devices. Client devices, 200, administrator devices 201, and servers 202 may communicate via one or more networks, such as a wide area network (WAN) such as the Internet, a local area network (LAN), or a combination of networks of any type, including cellular networks, broadband networks, satellite networks, Ethernet networks, wireless networks (e.g. 802.11 or WiFi, Bluetooth, etc.), or any other type and form of network or networks. Such networks may include additional devices not illustrated, such as routers, switches, access points, gateways, firewalls, accelerators, etc.

Client devices 200 and administrator devices 201 may execute an application 230 such as a web browser or other such application for accessing server 202. In many implementations, the application 230 for client devices 200 and administrators 201 may be identical (e.g. a web browser), while in other implementations, administrators 201 may have a different application (e.g. a dedicated application for report generation and/or analysis).

Server 202 may comprise one or more processors 204, such as CPUs, GPUs, tensor processing units (TPUs), or other such processors or co-processors. In some implementations, server 202 may include one or more main processors as well as one or more specialized co-processors for executing a machine learning algorithm (e.g. FPGAs, ASICs, etc.). Server 202 may also comprise one or more network interfaces 206 for communicating with clients 200 and administrators 201, as well as one or more input/output interfaces 208, in some implementations. Server 202 may also comprise one or more memory devices 210 for storing data and executable applications, which may be internal to server 202 or external (e.g. network attached storage, cloud storage, external hard drives, etc.).

Server 202 may execute a web server 212 for providing web pages and/or other content 214, such as web applications (e.g. hosted applications or software-as-a-service (SaaS) applications), database applications, or other such applications or content to client devices 200 and/or administrator devices 201. In many implementations, a plurality of servers 202 may execute a corresponding plurality of web servers 212 for load balancing or scalability to provide data to a large number of client devices 200.

Server 202 may execute a real-time monitor 216 for tracking interactions of client devices 200 with content data 214 via web server 212. Real-time monitor 216 may comprise an application, service, server, applet, plug-in, daemon, routine, or other executable logic for maintaining a state of client devices 200 accessing content data 214, and/or for recording access to content data 214 (e.g. by monitoring requests to web server 212 and/or receiving requests or notifications from applications 230 of clients 200, such as tracking pings, timer values, etc. sent in response to scripts embedded in content data 214 and executed by client applications 230). As discussed above, real-time monitor 216 may record in monitor database 218 records for each client device including access to navigation and detail pages, durations of access, scrolling amounts, session durations, session intervals, etc. Real-time monitor 216 may also aggregate session information, including total durations and total intervals as discussed above. Although shown on server 202, in some implementations, real-time monitor 216 may be executed by a client device 200, e.g. as a plug-in or script executed by application 230 and embedded in content data 214. This may distribute monitoring requirements to clients allowing for lower use of processor and memory resources of the server and increasing scalability.

In some implementations, real-time monitor 216 may also calculate a score for each client device, such as via coefficients multiplied by monitored metrics as discussed above. In other implementations, server 202 may execute a machine learning engine 220, which may comprise a classifier, such as a k-NN classifier, Bayes classifier, support vector machine, decision tree, neural network, or any other type and form of classifier to generate a score for a client device according to monitor data 218. As discussed above, in some implementations, metrics measured by a real-time monitor 216 may be provided to machine learning engine 220 for predicting a score, classification, predicting an anomalous or specified behavior, or predicting success or failure of an access session by a client device. As discussed above, success or failure may refer to successful access to a given content item, or may refer to a session in which a specified goal is completed (e.g. completion of authentication, transmission of specified data, completion of a transaction, etc.).

In some implementations, server 202 may execute a report generator 222. Report generator 222 may comprise an application, service, server, daemon, routine, or other executable logic for providing classifications or scores generated by a real-time monitor 216 and/or machine learning engine 220 in a viewable form to administrators 201. In some implementations, report generator 222 may comprise an application for generating a lane-based display as shown in FIG. 1C, which may be provided as a web application, web page, executable code, data for execution by an application 230, or any other such type and format. As discussed above, the generated report or display may be interactive, allowing an administrator to retrieve data about a client device and/or interact with the client device (e.g. by performing a proactive or mitigation action).

FIG. 2B is a flow chart of a method for real-time tracking of client data access, according to some implementations. As discussed above, a real-time monitor 216 may monitor interactions of a client device with a web site (e.g. a path from page to page or a series of requests) and maintain a state machine for each client device during an access session. The state or session information may be provided to a machine learning system or classifier to determine a score for the client, and based on a comparison to a threshold, a proactive or mitigation action may be taken.

At step 250, in some implementations, a server such as a web server 212 may receive a request for a content item such as a web page, graphic on a web page, script, or other such item. The request may come from a client device, including from an application 230 on a client device and/or a plug-in or script executed within such an application. The request may comprise an identification of the client device. In some implementations, the identification may be explicit (e.g., a cookie, user name or identifier, or other such identifier) while in other implementations, the identification may be implicit (e.g. a set of configuration data that individually does not identify a device, but in combination may narrow down the device identification, such as a browser type, an operating system version, an IP address, a time zone, a geographic location, a set of installed applications, or any other such information). At step 252, a real-time monitor of the server may identify the client device from the identification information in the request. Identifying the client device may comprise extracting the identifier, or may comprise assembling an identifier from implicit information (e.g., concatenating the information, calculating a hash of the information, etc.).

If the client is a new client (e.g., not previously identified or for which a record does not exist), then at step 254, a record may be generated for the client. The record may follow the schema of FIG. 2B or any similar implementation, and may identify the device, the session, the requested page, etc. At step 256, a session state machine may be initiated for the device, identifying the current page or content item being accessed (or likely being accessed, for example, as the last requested page or content item and prior to a timeout). The state machine may comprise a record in the database or entry within the record identifying the device, the accessed content item, and the time, or any other such information (e.g. a visit depth, visit duration, navigation item, etc.). Similarly, if the client is not a new client, but the session is a new session (e.g. no record exists for this session, while a record does exist for the device), then a session state machine may be initiated at step 256.

If the session is not a new session (e.g. if this is not the first content item accessed during the session), then at step 258, the session state machine may be updated. This may comprise adding a new record or updating a record of the visit, updating a session duration or depth value, resetting a session time out timer, etc.

At step 260, in some implementations, the session information may be aggregated. For example, in some implementations, a multi-dimensional vector may be generated with dimensional values corresponding to recorded or measured values for the device (e.g. session duration, session depth, type, per session interval, aggregated duration or interval, navigation depth, identifications of specific pages or content accessed, etc.). In other implementations, the information may be aggregated in other suitable means (e.g. as an array, concatenated string of values with or without delimiters, etc.).

At step 262, a score may be determined for the device. In some implementations, a score may be generated as a weighted sum of factors, as discussed above. In other implementations, the score may be generated by a machine learning classifier trained on logs of previous visits or sessions by the device or other devices, with the score representing an anomaly, potential conversion, inclusion of the device within a subset, etc. Accordingly, in some implementations, the score may be a confidence score of a classification (e.g. classified within subset A with a confidence score of nn % or 0.nn).

At step 264, the server may determine if the score exceeds a threshold. The threshold may be set by an administrator or user, or dynamically modified by a machine learning engine as more data is acquired from the device and/or other devices (e.g. dynamically adjusted such that a fixed percentage n of calculated scores exceeds the threshold, such as the top 10% of scores, regardless of the specific score values). If the score does not exceed the threshold, then in some implementations, at step 270, the server may determine whether a session timeout time has expired (e.g. a predetermined number of seconds or minutes since the last receipt of a request to access a content item at step 250). This may be done for garbage collection purposes or to terminate state machines (e.g. at step 272) in case a client device has terminated its local application 230, restarted, disconnected from a network, etc., and to avoid having a session last an infinite time. If the time has expired, at step 272, then the session record may be closed and a new session record may be created when a request is next received from the device. Closing the session record may include setting a closed flag or other flag on the record to indicate the session is complete; opening a new blank session record for a subsequent session; or taking any other such action. If the session has not expired, step 270 may be repeated until either the timeout exceeds the session or a new request is received at step 250.

If the score exceeds the threshold at step 264, then at step 266 in some implementations, a notification may be transmitted to another device, such as a client device 201 of an administrator or administrator device 201. In some implementations, the notification may comprise an identification of the session record and/or device record, an identification of a content item last accessed by the client device, etc. At step 268, in some implementations, a device-to-device or inter-client communication session may be automatically initiated between the administrator device and the client device. The inter-client communication session may comprise a chat session, video or audio teleconference session, remote control (e.g. remote desktop) session, or any other type and form of communication sessions.

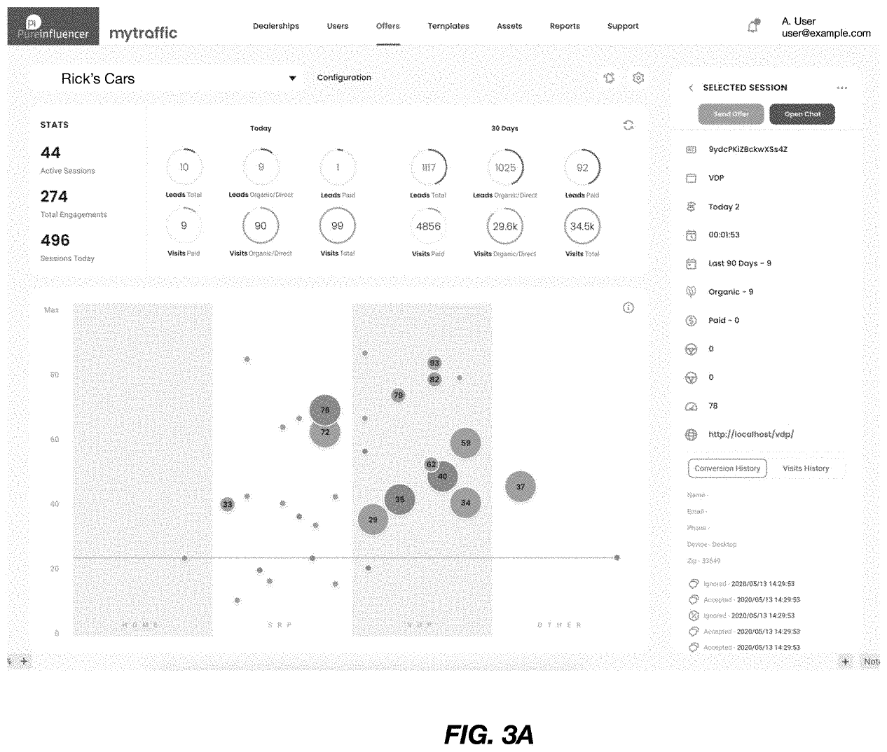

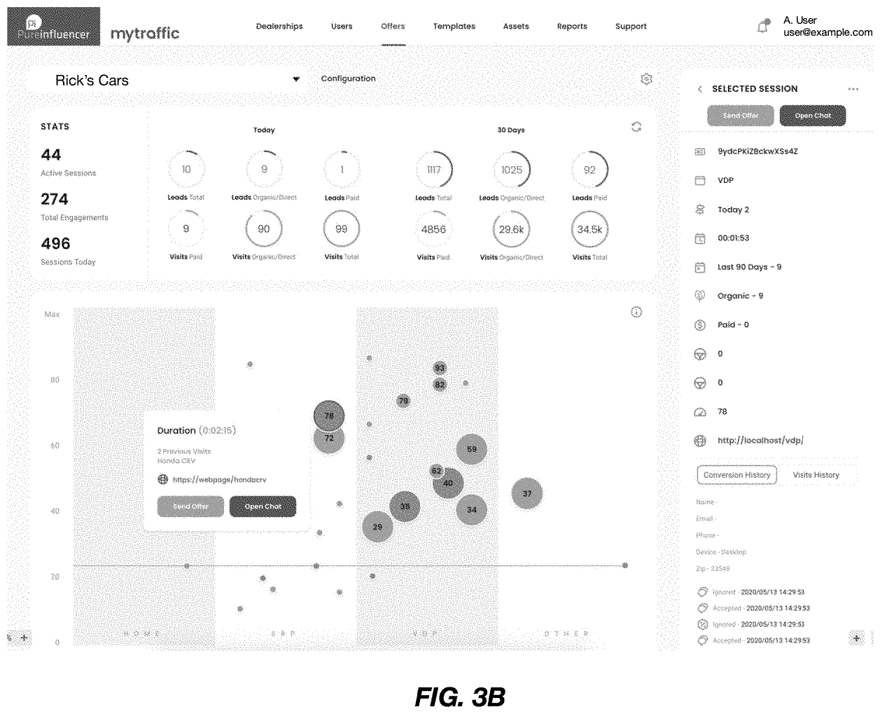

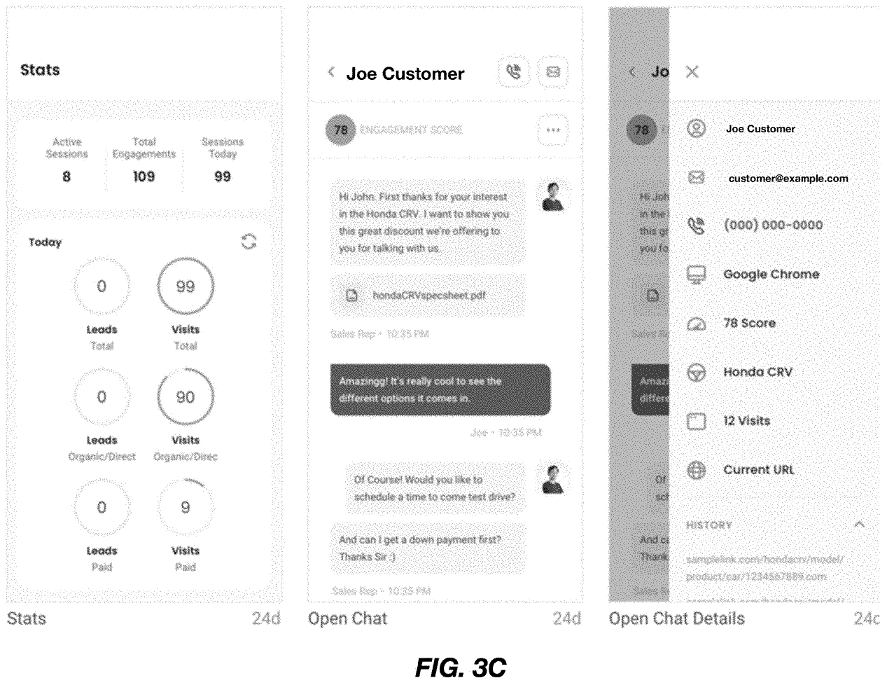

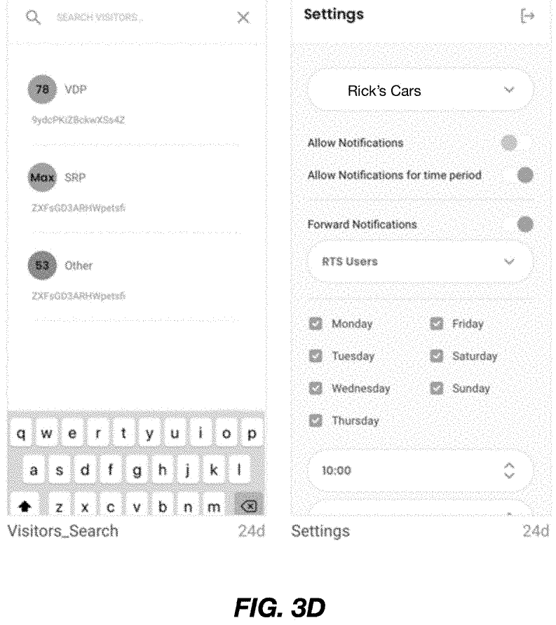

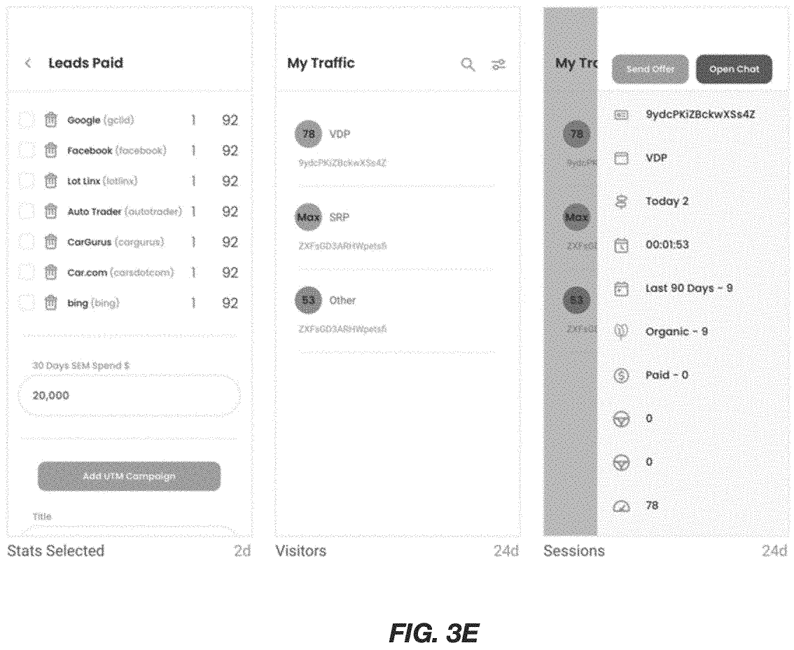

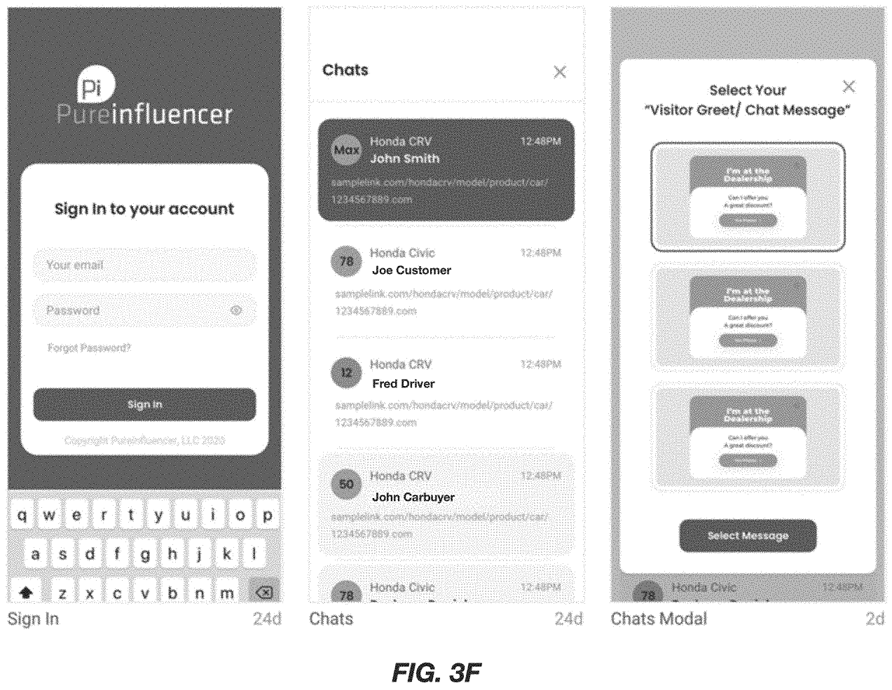

FIGS. 3A-3F are screenshots of user interfaces of a system for real-time tracking of client data access, according to some implementations. As shown in FIG. 3A, a lane-based display may be utilized to monitor client device interactions in real-time and compare or analyze scores associated with client devices. As shown in FIG. 3B, upon selection of an icon for a client device, the system may display additional data about the client device as well as provide controls for proactive actions such as initiating a live chat or call, or providing additional content. Although shown in a full screen view for display upon a laptop or desktop computing device or tablet, a similar system may be utilized with displays having other form factors. For example, FIGS. 3C-3F show screenshots of a mobile phone application for real-time tracking of client data access.

Accordingly, the systems and methods discussed herein provide for real-time tracking or monitoring of client device access during sessions as well as across or between sessions, and aggregation of monitoring data. Monitored data may be used to generate predictive scores for identification of anomalous or non-anomalous behavior, or predict success or failure of an access session or access to a given content item or page. By utilizing real-time monitoring and analysis, administrators may take proactive or mitigation actions dynamically, without waiting for requests from users of client devices and without the delay of offline analysis of logs.

In a first aspect, the present disclosure is directed to a method for real-time tracking of client data access. The method includes receiving, by a first computing device from a second computing device, a request to access a content item. The method also includes providing, by the first computing device to the second computing device, access to the content item. The method also includes updating, by the first computing device, a state machine for the second computing device, the state machine identifying the access to the content item by the second computing device. The method also includes calculating, by the first computing device, a score for the second computing device based on the state of the state machine. The method also includes determining, by the first computing device, that the score for the second computing device exceeds a threshold. The method also includes, responsive to the determination, transmitting, by the first computing device to a third computing device, a notification of the score for the second computing device.

In some implementations, the method includes, for each of a plurality of requests from the second computing device to access an additional content item: providing, by the first computing device to the second computing device, access to the requested additional content item; and updating, by the first computing device, the state machine for the second computing device, the state machine further identifying an ordered sequence of access to content items by the second computing device. In a further implementation, calculating the score for the second computing device is further based on the ordered sequence of access to content items by the second computing device identified by the state machine.

In some implementations, the method includes, responsive to the determination that the score for the second computing device exceeds the threshold, establishing a communication session between the second computing device and the third computing device. In some implementations, the method includes, for each of a plurality of additional computing devices, calculating a score based on a state of a state machine for the corresponding additional computing device. In a further implementation, the method includes setting the threshold, by the first computing device, to filter a predetermined percentage of the calculated scores. In a further implementation, the method includes transmitting a notification of each of the calculated scores to the third computing device.

In some implementations, the method includes calculating the score by generating a multi-dimensional vector corresponding to encoded values of the state machine; and processing the multi-dimensional vector according to a classifier trained from a plurality of scores from a corresponding plurality of additional computing devices. In some implementations, the method includes calculating a weighted sum of a plurality of encoded values of the state machine, each encoded value representing a different one of a number of access sessions, an aggregated access session duration, an aggregated access session interval, a per access session duration, a per access session interval, a number of content items accessed during a session, or an access depth of the session.

In some implementations, the method includes terminating the state machine for the second computing device, by the first computing device, responsive to an expiration of a timer reset upon receipt of a previous access request from the second computing device.

In another aspect, the present disclosure is directed to a system for real-time tracking of client data access. The system includes a first computing device comprising a processor and a network interface in communication with a second computing device and a third computing device. The processor is configured to: receive, via the network interface from the second computing device, a request to access a content item; provide, via the network interface to the second computing device, access to the content item; update a state machine for the second computing device, the state machine identifying the access to the content item by the second computing device; calculate a score for the second computing device based on the state of the state machine; determine that the score for the second computing device exceeds a threshold; and responsive to the determination, transmit, via the network interface to the third computing device, a notification of the score for the second computing device.

In some implementations, the processor is further configured to, for each of a plurality of requests from the second computing device to access an additional content item: provide, to the second computing device, access to the requested additional content item; and update the state machine for the second computing device, the state machine further identifying an ordered sequence of access to content items by the second computing device.

In some implementations, calculating the score for the second computing device is further based on the ordered sequence of access to content items by the second computing device identified by the state machine. In some implementations, the processor is further configured to, responsive to the determination that the score for the second computing device exceeds the threshold, establish a communication session between the second computing device and the third computing device.

In some implementations, the processor is further configured to, for each of a plurality of additional computing devices, calculate a score based on a state of a state machine for the corresponding additional computing device. In a further implementation, the processor is further configured to set the threshold to filter a predetermined percentage of the calculated scores. In another further implementation, the processor is further configured to transmit a notification of each of the calculated scores to the third computing device.

In some implementations, the processor is further configured to generate a multi-dimensional vector corresponding to encoded values of the state machine; and process the multi-dimensional vector according to a classifier trained from a plurality of scores from a corresponding plurality of additional computing devices.

In some implementations, the processor is further configured to calculate a weighted sum of a plurality of encoded values of the state machine, each encoded value representing a different one of a number of access sessions, an aggregated access session duration, an aggregated access session interval, a per access session duration, a per access session interval, a number of content items accessed during a session, or an access depth of the session.

In some implementations, the processor is further configured to terminate the state machine for the second computing device, responsive to an expiration of a timer reset upon receipt of a previous access request from the second computing device.

### B. Computing Environment

Having discussed specific embodiments of the present solution, it may be helpful to describe aspects of the operating environment as well as associated system components (e.g., hardware elements) in connection with the methods and systems described herein.

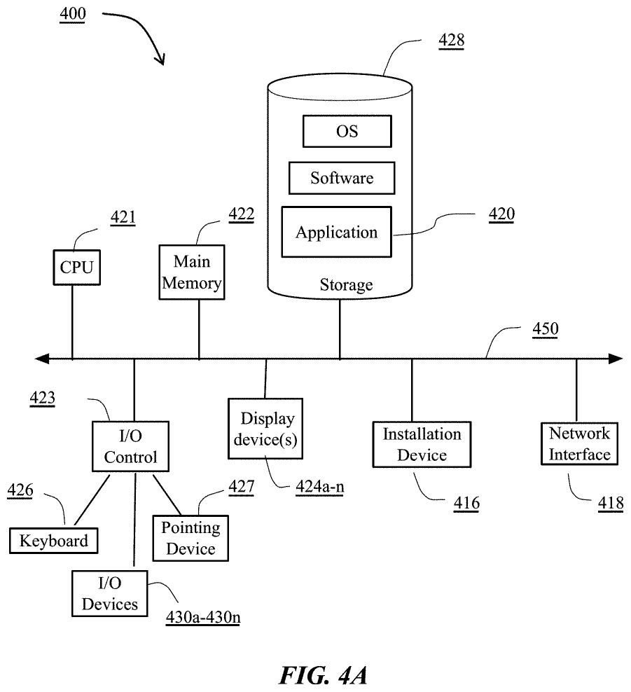

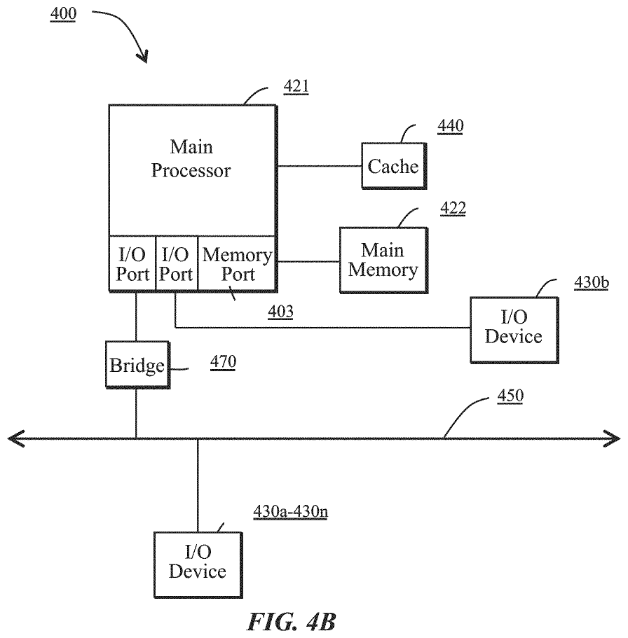

The systems discussed herein may be deployed as and/or executed on any type and form of computing device, such as a computer, network device or appliance capable of communicating on any type and form of network and performing the operations described herein. FIGS. 4A and 4B depict block diagrams of a computing device 400 useful for practicing an embodiment of the wireless communication devices 402 or the access point 406. As shown in FIGS. 4A and 4B, each computing device 400 includes a central processing unit 421, and a main memory unit 422. As shown in FIG. 4A, a computing device 400 may include a storage device 428, an installation device 416, a network interface 418, an I/O controller 423, display devices 424a-424n, a keyboard 426 and a pointing device 427, such as a mouse. The storage device 428 may include, without limitation, an operating system and/or software. As shown in FIG. 4B, each computing device 400 may also include additional optional elements, such as a memory port 403, a bridge 470, one or more input/output devices 430a-430n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 400 may be based on any of these processors, or any other processor capable of operating as described herein.

Main memory unit 422 may be one or more memory chips capable of storing data and allowing any storage location to be directly accessed by the microprocessor 421, such as any type or variant of Static random access memory (SRAM), Dynamic random access memory (DRAM), Ferroelectric RAM (FRAM), NAND Flash, NOR Flash and Solid State Drives (SSD). The main memory 422 may be based on any of the above described memory chips, or any other available memory chips capable of operating as described herein. In the embodiment shown in FIG. 4A, the processor 421 communicates with main memory 422 via a system bus 450 (described in more detail below). FIG. 4B depicts an embodiment of a computing device 400 in which the processor communicates directly with main memory 422 via a memory port 403. For example, in FIG. 4B the main memory 422 may be DRDRAM.

FIG. 4B depicts an embodiment in which the main processor 421 communicates directly with cache memory 440 via a secondary bus, sometimes referred to as a backside bus. In other embodiments, the main processor 421 communicates with cache memory 440 using the system bus 450. Cache memory 440 typically has a faster response time than main memory 422 and is provided by, for example, SRAM, BSRAM, or EDRAM. In the embodiment shown in FIG. 4B, the processor 421 communicates with various I/O devices 430 via a local system bus 450. Various buses may be used to connect the central processing unit 421 to any of the I/O devices 430, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4B depicts an embodiment of a computer 400 in which the main processor 421 may communicate directly with I/O device 430b, for example via HYPERTRANSPORT, RAPIDIO, or INFINIBAND communications technology. FIG. 4B also depicts an embodiment in which local busses and direct communication are mixed: the processor 421 communicates with I/O device 430a using a local interconnect bus while communicating with I/O device 430b directly.

A wide variety of I/O devices 430a-430n may be present in the computing device 400. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 423 as shown in FIG. 4A. The I/O controller may control one or more I/O devices such as a keyboard 426 and a pointing device 427, e.g., a mouse or optical pen. Furthermore, an I/O device may also provide storage and/or an installation medium 416 for the computing device 400. In still other embodiments, the computing device 400 may provide USB connections (not shown) to receive handheld USB storage devices such as the USB Flash Drive line of devices manufactured by Twintech Industry, Inc. of Los Alamitos, Calif.

Referring again to FIG. 4A, the computing device 400 may support any suitable installation device 416, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 400 may further include a storage device, such as one or more hard disk drives or redundant arrays of independent disks, for storing an operating system and other related software, and for storing application software programs such as any program or software 420 for implementing (e.g., configured and/or designed for) the systems and methods described herein. Optionally, any of the installation devices 416 could also be used as the storage device. Additionally, the operating system and the software can be run from a bootable medium.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 400 communicates with other computing devices 400′ via any type and/or form of gateway or tunneling protocol such as Secure Socket Layer (SSL) or Transport Layer Security (TLS). The network interface 418 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

In some embodiments, the computing device 400 may include or be connected to one or more display devices 424a-424n. As such, any of the I/O devices 430a-43On and/or the I/O controller 423 may include any type and/or form of suitable hardware, software, or combination of hardware and software to support, enable or provide for the connection and use of the display device(s) 424a-424n by the computing device 400. For example, the computing device 400 may include any type and/or form of video adapter, video card, driver, and/or library to interface, communicate, connect or otherwise use the display device(s) 424a-424n. In one embodiment, a video adapter may include multiple connectors to interface to the display device(s) 424a-424n. In other embodiments, the computing device 400 may include multiple video adapters, with each video adapter connected to the display device(s) 424a-424n. In some embodiments, any portion of the operating system of the computing device 400 may be configured for using multiple displays 424a-424n. One ordinarily skilled in the art will recognize and appreciate the various ways and embodiments that a computing device 400 may be configured to have one or more display devices 424a-424n.

In further embodiments, an I/O device 430 may be a bridge between the system bus 450 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 400 of the sort depicted in FIGS. 4A and 4B may operate under the control of an operating system, which control scheduling of tasks and access to system resources. The computing device 400 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 400 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 400 has sufficient processor power and memory capacity to perform the operations described herein.

In some embodiments, the computing device 400 may have different processors, operating systems, and input devices consistent with the device. For example, in one embodiment, the computing device 400 is a smart phone, mobile device, tablet or personal digital assistant. In still other embodiments, the computing device 400 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 400 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

What is claimed:

1. A method for real-time tracking of client data access, comprising:
receiving, by a first computing device from a second computing device, a request to access a content item;
providing, by the first computing device to the second computing device, access to the content item;
updating, by the first computing device, a state machine for the second computing device, the state machine identifying the access to the content item by the second computing device;
calculating, by the first computing device, a score for the second computing device based on the state of the state machine;
determining, by the first computing device, that the score for the second computing device exceeds a threshold; and
responsive to the determination, transmitting, by the first computing device to a third computing device, a notification of the score for the second computing device.

2. The method of claim 1, further comprising, for each of a plurality of requests from the second computing device to access an additional content item:
providing, by the first computing device to the second computing device, access to the requested additional content item; and
updating, by the first computing device, the state machine for the second computing device, the state machine further identifying an ordered sequence of access to content items by the second computing device.

3. The method of claim 2, wherein calculating the score for the second computing device is further based on the ordered sequence of access to content items by the second computing device identified by the state machine.

4. The method of claim 1, further comprising, responsive to the determination that the score for the second computing device exceeds the threshold, establishing a communication session between the second computing device and the third computing device.

5. The method of claim 1, further comprising, for each of a plurality of additional computing devices, calculating a score based on a state of a state machine for the corresponding additional computing device.

6. The method of claim 5, further comprising setting the threshold, by the first computing device, to filter a predetermined percentage of the calculated scores.

7. The method of claim 5, further comprising transmitting a notification of each of the calculated scores to the third computing device.

8. The method of claim 1, wherein calculating the score further comprises generating a multi-dimensional vector corresponding to encoded values of the state machine; and processing the multi-dimensional vector according to a classifier trained from a plurality of scores from a corresponding plurality of additional computing devices.

9. The method of claim 1, wherein calculating the score further comprises calculating a weighted sum of a plurality of encoded values of the state machine, each encoded value representing a different one of a number of access sessions, an aggregated access session duration, an aggregated access session interval, a per access session duration, a per access session interval, a number of content items accessed during a session, or an access depth of the session.

10. The method of claim 1, further comprising terminating the state machine for the second computing device, by the first computing device, responsive to an expiration of a timer reset upon receipt of a previous access request from the second computing device.

11. A system for real-time tracking of client data access, comprising:
a first computing device comprising a processor and a network interface in communication with a second computing device and a third computing device;
wherein the processor is configured to:
receive, via the network interface from the second computing device, a request to access a content item,
provide, via the network interface to the second computing device, access to the content item,
update a state machine for the second computing device, the state machine identifying the access to the content item by the second computing device,
calculate a score for the second computing device based on the state of the state machine,
determine that the score for the second computing device exceeds a threshold, and
responsive to the determination, transmit, via the network interface to the third computing device, a notification of the score for the second computing device.

12. The system of claim 11, wherein the processor is further configured to, for each of a plurality of requests from the second computing device to access an additional content item:
provide, to the second computing device, access to the requested additional content item; and
update the state machine for the second computing device, the state machine further identifying an ordered sequence of access to content items by the second computing device.

13. The system of claim 12, wherein calculating the score for the second computing device is further based on the ordered sequence of access to content items by the second computing device identified by the state machine.

14. The system of claim 11, wherein the processor is further configured to, responsive to the determination that the score for the second computing device exceeds the threshold, establish a communication session between the second computing device and the third computing device.

15. The system of claim 11, wherein the processor is further configured to, for each of a plurality of additional computing devices, calculate a score based on a state of a state machine for the corresponding additional computing device.

16. The system of claim 15, wherein the processor is further configured to set the threshold to filter a predetermined percentage of the calculated scores.

17. The system of claim 15, wherein the processor is further configured to transmit a notification of each of the calculated scores to the third computing device.

18. The system of claim 11, wherein the processor is further configured to generate a multi-dimensional vector corresponding to encoded values of the state machine; and process the multi-dimensional vector according to a classifier trained from a plurality of scores from a corresponding plurality of additional computing devices.

19. The system of claim 11, wherein the processor is further configured to calculate a weighted sum of a plurality of encoded values of the state machine, each encoded value representing a different one of a number of access sessions, an aggregated access session duration, an aggregated access session interval, a per access session duration, a per access session interval, a number of content items accessed during a session, or an access depth of the session.

20. The system of claim 11, wherein the processor is further configured to terminate the state machine for the second computing device, responsive to an expiration of a timer reset upon receipt of a previous access request from the second computing device.
